(19) United States
(12) Patent Application Publication
(10) Pub. No.: US 2002/0193137 A1
(43) Pub. Date: Dec. 19, 2002

(54) Mobile telephone

(75) Inventors: Graham Bank, Suffolk (GB); Neil Simon Owen, Cambridgeshire (GB)

Correspondence Address: FOLEY AND LARDNER, SUITE 500, 3000 K STREET NW, WASHINGTON, DC, 20007, US

(73) Assignee: NEW TRANSDUCERS LIMITED

(21) Appl. No.: 10/005,367

(22) Filed: Dec. 7, 2001

Related U.S. Application Data
(60) Provisional application No. 60/298,081, filed on Jun. 15, 2001.

(30) Foreign Application Priority Data
Jun. 14, 2001 (GB) GB 0114501.0

(51) Int. Cl. H04B 1/38

(52) U.S. Cl. 455/550; 455/90

(57) ABSTRACT

A mobile telephone (10) comprising a body (12) and a bending wave loudspeaker which comprises a panel-form member (14) capable of supporting bending waves and a transducer (24) mounted to the panel-form member to excite bending wave vibration in the panel-form member to produce an acoustic output. The body (12) defines an open-faced cavity (16) and the panel-form member is movable between first and second positions with the panel-form member covering the open face of the cavity (16) when in the first position, and spaced away from the cavity when in the second position.

This application claims the benefit of U.S. provisional application No. 60/298,081, filed Jun. 15, 2001.

### FIELD OF THE INVENTION

The invention relates to a mobile telephone or cell phone and, in particular, one which comprises a member (e.g. a cover for buttons/display) which may be moved between open and closed positions.

### BACKGROUND

It is known from commonly assigned WO00/02417 to provide a mobile telephone or cell phone comprising a display screen, a resonant panel-form member, at least a portion of which is transparent and through which the display screen is visible, and a vibration exciter which causes the panel-form member to resonate to act as an acoustic radiator or loudspeaker. The resonant bending wave panel-form member loudspeakers used may be of the kind described in WO97/09842 and U.S. counterpart application Ser. No. 08/707,012, filed Sep. 3, 1996 (the latter incorporated herein by reference), which are generally known as distributed mode loudspeakers.

For loudspeakers such as those proposed in WO00/02417 to provide a broad acoustic output range, in particular, to provide an adequate low frequency response, it is necessary to mount a closed, shallow box behind the loudspeaker. The use of such a box is described in detail in commonly assigned WO99/52322. The box adds bulk to such a loudspeaker unit and thus it is an object of the invention to provide a more compact loudspeaker unit, particularly for use with a flip lid mobile phone.

### SUMMARY OF THE INVENTION

According to the invention there is provided a mobile telephone comprising a body and a bending wave loudspeaker mounted on the body which comprises a panel-form member capable of supporting bending waves and a transducer mounted to the panel-form member to excite bending wave vibration in the panel-form member to produce an acoustic output. The body defines an open-faced cavity and the panel-form member is movable between first and second positions with the panel-form member covering the open face of the cavity when in the first position, and spaced away from the cavity when in the second position.

With the panel-form member in the first position, a volume of air is enclosed in the cavity, the cavity being configured to define rear boundary conditions of the loudspeaker that ensure the loudspeaker has a desired bandwidth when operating with the panel-form member in the first (closed) position. Thus, the problem of providing a broad acoustic output range, in particular, of providing an adequate low frequency response without increasing the depth or bulk of the mobile phone, is solved by using the existing trapped air volume under the phone lid when in the closed condition.

In the second position, the panel-form member is spaced away from the cavity and thus there may be an acoustic short circuit which reduces the bandwidth of the loudspeaker. In effect, the cavity may be considered equivalent to the cavities or baffles described in WO99/52322 and U.S. counterpart application Ser. No. 09/287,109, filed Apr. 7, 1999 (the latter incorporated herein by reference), and thus the cavity and the panel-form member may form a coupled system with coupled modes. The cavity may thus be considered as a shallow tray containing a fluid, e.g. air, whose surface may be considered to have wave-like behaviour and whose specific properties depend on both the fluid and the geometry of the cavity. The panel-form member is placed in coupled contact with the fluid surface and the wave excitation on a surface of the panel-form member excites the fluid. Conversely, the natural wave properties of the fluid interact with the panel-form member, so modifying the panel-form member's behaviour. Thus, the existing trapped air volume defines the rear boundary conditions of the loudspeaker. By adjusting these conditions, it is possible to allow the loudspeaker to have a given bandwidth at a particular distance.

The body may also be considered to act as a baffle for the loudspeaker with the panel-form member in the first position since it prevents an acoustic short circuit between the acoustic output of the opposite surfaces of the panel-form member.

With the panel-form member in the first or closed position, the mobile phone may be used in hands free conference mode since the loudspeaker provides a broad bandwidth. With the panel-form member in the second or open position, the mobile phone may only be used effectively in handset mode, i.e. standard use by a user's ear. This is because in handset mode the close proximity of the panel-form member to a user's head provides a sufficient degree of self-baffling which reduces the effects of the acoustic short circuit and hence the loudspeaker may have adequate low frequency response and a broad bandwidth.

The cavity may be sealed by the aid of a resilient member disposed between the panel-form member and the body when the panel-form member is in the first position. The cavity may be sealed to prevent all radiation leaking from the cavity or to prevent radiation which has an acoustic resistance which affects the bandwidth of the loudspeaker leaking from the cavity. The resilient member may be a ring of foamed plastic or rubber. The resilient member may be mounted in a groove on the body of the phone or alternatively may be mounted around the edge of the lid.

The mobile phone may comprise a screen mounted in the body. The panel-form member may be transparent or alternatively may comprise a transparent portion whereby the screen may be viewed with the lid in the closed position. The transducer may be mounted at or near an edge of the panel-form member (i.e., at a marginal position) and spaced away from the transparent portion of the panel-form member so as not to obscure a user's view of the screen. When the panel-form member is edge-driven by a marginally mounted transducer, a narrow surrounding wall may be mounted to and project from a surface of the panel-form member. In this way, a simply supported boundary condition for the panel-form member is formed which may enable efficient use of the edge drive. The wall may also support the resilient member.

The transducer may be an inertial or grounded vibration transducer, actuator or exciter, e.g. moving coil transducer. Alternatively, the transducer may be a piezoelectric transducer and may be in the form of a strip of piezoelectric material. The transducer may be a bender or torsional transducer, e.g. of the type taught in commonly assigned WO00/13464 and U.S. counterpart application Ser. No. 09/384,419, filed Aug. 27, 1999 (the latter incorporated herein by reference). The transducer may be transparent.

The panel-form member is preferably mounted to the body via a hinge. The panel-form member may thus act as a lid or cover to a display screen, microphone and/or touch pad which may be mounted in the body. The loudspeaker may be a dual function loudspeaker and may act as both loudspeaker and microphone.

The bending wave loudspeaker may be a resonant bending wave mode loudspeaker of the kind described in WO 97/09842 and U.S. Ser. No. 08/707,012. In other words, the loudspeaker may comprise a resonant panel-form member and a transducer mounted to the panel-form member to cause the panel-form member to resonate and act as an acoustic radiator.

### BRIEF DESCRIPTION OF THE DRAWING

Examples that embody the best mode for carrying out the invention are described in detail below and are diagrammatically illustrated in the accompanying drawing, in which:

FIG. 1 is a schematic perspective view of a flip-lid mobile phone according to the present invention showing the lid in the first (closed) position;

FIG. 2 is a schematic perspective view of the mobile phone of FIG. 1 showing the lid in the second (open) position;

FIG. 3a is a schematic top plan view of the mobile phone of FIGS. 1 and 2 with the lid open;

FIG. 3b is a schematic side elevational view of the mobile phone of FIG. 3a; and

FIG. 4 is a perspective view of a lid of a flip-lid mobile phone according to another embodiment of the present invention.

It is to be understood that the invention is not limited in its application to the details of construction and the arrangement of components set forth in the following description or illustrated in the drawing figures.

### DETAILED DESCRIPTION

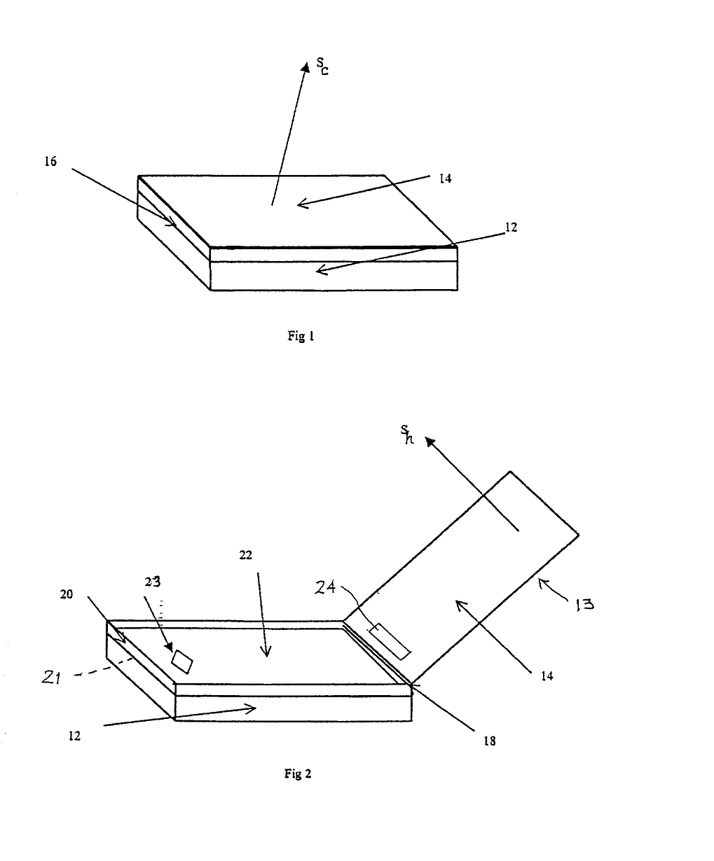

In FIGS. 1, 2, 3a and 3b there is shown a mobile phone (10) comprising a body (12) and a lid (13) which is mounted to the body via a hinge (18). The lid (13) is moveable between a closed position in which the lid covers the body (12) as shown in FIG. 1, and an open position in which the lid (13) is at an angle of approximately 135° to the body (12) as shown in FIG. 2. The mobile phone may also comprise a screen (22) which is covered by the lid (13) when in the closed position. The mobile phone also comprises a microphone (23) mounted in the body (12).

The lid (13) is formed from a panel-form member (14) which is capable of supporting bending wave vibration, in particular, resonant bending wave modes. A transducer (24) is mounted to the panel-form member (14) to excite bending wave vibration in the panel-form member so as to form a bending wave loudspeaker, e.g. a resonant bending wave loudspeaker of the type known from WO97/09842 and U.S. Ser. No. 08/707,012.

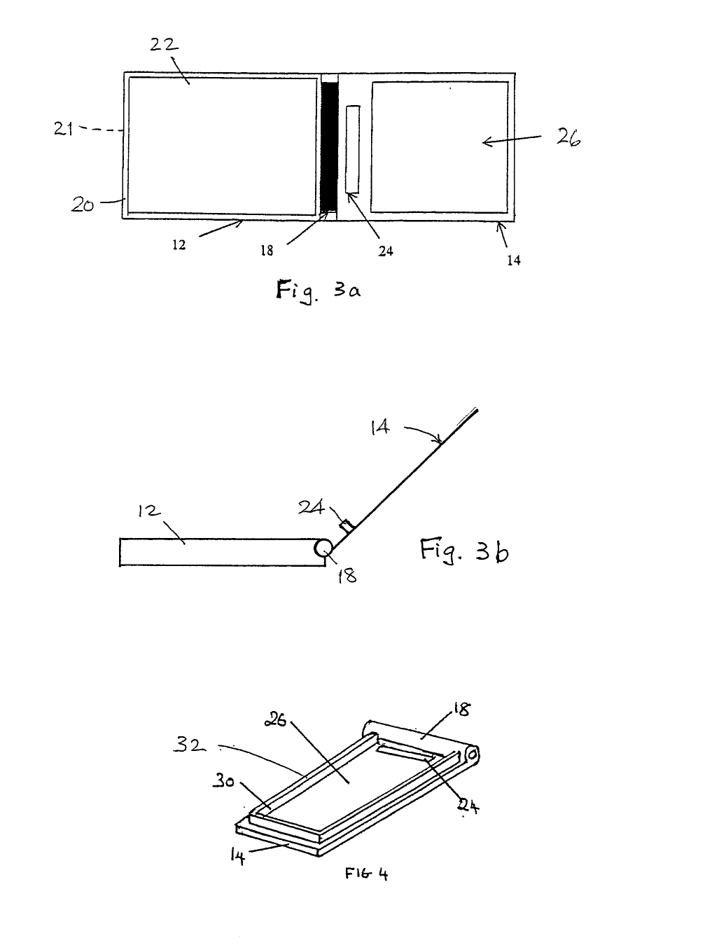

The panel-form member (14) may be transparent or alternatively may comprise a transparent portion (26) as shown in FIG. 3a. By using a transparent or partially transparent panel-form member (14), the optional screen (22) may be viewed with the lid in the closed position. Clearly, the screen will also be visible when the lid is open. As shown in FIG. 3a, the transducer (24) is mounted in a marginal position at or near an edge of the panel-form member (14) and is spaced away from the transparent portion of the panel-form member (14) so as not to obscure the user's view of the screen (22).

The body (12) of the mobile phone (10) comprises an open-faced cavity (16) behind the optional screen (22). As shown more clearly in FIG. 2, the cavity (16) is closed by the lid (13) when the lid is in the closed position. The cavity (16) is sealed in the closed position since the lid abuts against a seal (20) in the form of a ring of foam or rubber which sits in a groove (21) on the body of the phone.

The mobile phone has two modes of operation, namely hands-free conference mode as shown in FIG. 1, and handset mode, i.e. against a user's ear, as shown in FIG. 2.

In conference mode, the sealed cavity (16) defines the rear boundary conditions of the loudspeaker, the cavity being configured to ensure that the loudspeaker has a desired bandwidth. As shown in FIG. 1 the lid is closed and the loudspeaker is effectively mounted in a closed, shallow box. The acoustic output from the panel-form member (14) is emitted in the direction of arrow S_{c}, namely from the upper (outer) surface of the panel-form member (14). For conference mode operation the panel-form member/transducer may also act as a microphone in accordance with the teachings of commonly assigned U.S. Pat. No. 6,307,942 (incorporated herein by reference). Alternatively, a separate microphone (not shown) may be built into the body (12), exposed along any surface thereof.

In FIG. 2 the lid is shown open and thus the loudspeaker is spaced away from the cavity. Thus an acoustic short circuit is created which reduces the low frequency capability of the loudspeaker. However, when the mobile phone is used in handset mode, there is a sufficient degree of self-baffling to restore the required low frequencies. The useful acoustic output from the panel-form member (14) is emitted in the direction of arrow Sₕ, namely from the inner face of the panel-form member (14).

In FIG. 4, there is shown a lid of a mobile phone which is similar to those shown in the previous figures and, thus, items in common have the same reference numbers. The lid is formed from a panel-form member (14) to which a transducer (24) is mounted. A narrow wall (30) is mounted to and surrounds a transparent portion (26) of the panel-form member (14). The wall (30) is generally U-shaped with its ends being attached to the hinge (18). The wall (30) may support a resilient seal (32).

The panel-form member (14) of either embodiment may be as taught in WO97/09842 and U.S. Ser. No. 08/707,012, and thus the properties of the panel-form member may be chosen to distribute the resonant bending wave modes substantially evenly in frequency. In other words, the properties or parameters, e.g. size, thickness, shape, material etc., of the panel-form member may be chosen to smooth peaks in the frequency response caused by “bunching” or clustering of the modes. The resultant distribution of resonant bending wave modes may thus be such that there are substantially minimal clusterings and disparities of spacing.

In particular, the properties of the panel-form member may be chosen to distribute the lower frequency resonant bending wave modes substantially evenly in frequency. The number of resonant bending wave modes is less at lower frequency than at higher frequency and thus the distribution of the lower frequency resonant bending wave modes is particularly important. The lower frequency resonant bending wave modes are preferably the ten to twenty lowest frequency resonant bending wave modes of the acoustic radiator. The resonant bending wave modes associated with each conceptual axis of the panel-form member may be arranged to be interleaved in frequency. Each conceptual axis has an associated lowest fundamental frequency (conceptual frequency) and higher modes at spaced frequencies. By interleaving the modes associated with each axis, the substantially even distribution may be achieved. There may be two conceptual axes and the axes may be symmetry axes.

The transducer location may be chosen to couple substantially evenly to the resonant bending wave modes. In particular, the transducer location may be chosen to couple substantially evenly to lower frequency resonant bending wave modes. In other words, the transducer may be mounted at a location spaced away from nodes (or dead spots) of as many lower frequency resonant modes as possible. Thus the transducer may be at a location where the number of vibrationally active resonance anti-nodes is relatively high and conversely the number of resonance nodes is relatively low.

The use of a transparent portion (26) makes marginal positioning of the transducer (24) preferable. This can be accomplished while still enabling the above-described distributed mode operation of the panel-form member (14) in accordance with the teachings of commonly assigned WO99/37121 and U.S. counterpart application Ser. No. 09/233,037, filed Jan. 20, 1999 (the latter incorporated herein by reference).

Various modifications will be apparent to those skilled in the art without departing from the scope of the invention, which is defined by the appended claims.

1. A mobile telephone comprising a body and a bending wave loudspeaker mounted to the body which comprises a panel-form member capable of supporting bending waves and a transducer mounted to the panel-form member to excite bending wave vibration in the panel-form member to produce an acoustic output, wherein the body defines an open-faced cavity and the panel-form member is movable between a first position in which the panel-form member covers the open face of the cavity, and a second position in which the panel-form member is spaced away from the cavity.

2. A mobile telephone according to claim 1, wherein with the panel-form member in the first position, a volume of air is enclosed in the cavity, the cavity being configured to define rear boundary conditions of the loudspeaker that ensure the loudspeaker has a desired bandwidth when operating with the panel-form member in the first position.

3. A mobile telephone according to claim 2, wherein the cavity and the panel-form member form a coupled system with coupled modes.

4. The mobile telephone according to claim 1, claim 2 or claim 3, wherein the body acts as a baffle for the loudspeaker when the panel-form member is in the first position.

5. A mobile telephone according to claim 1, wherein with the panel-form member in the first position, the mobile phone is usable in hands-free conference mode.

6. A mobile telephone according to claim 1, wherein with the panel-form member in the second position, the mobile phone is usable in handset mode.

7. A mobile telephone according to claim 4, wherein the cavity is sealed by a resilient member disposed between the panel-form member and the body when the panel-form member is in the first position.

8. A mobile telephone according to claim 7, wherein the cavity is sealed to prevent acoustic radiation from leaking from the cavity.

9. A mobile telephone according to claim 7, wherein the resilient member is a ring of foamed plastic or rubber.

10. A mobile telephone according to claim 9, wherein the resilient member is mounted in a groove on the body.

11. A mobile telephone according to claim 7, wherein the resilient member is mounted in a groove on the body.

12. A mobile telephone according to claim 7, comprising a screen mounted in the body, the panel-form member comprising a transparent portion whereby the screen is visible with the panel-form member in the first position.

13. A mobile telephone according to claim 12, wherein the transducer is mounted at a marginal position on the panel-form member and is spaced away from the transparent portion so as not to obscure a user's view of the screen.

14. A mobile telephone according to claim 13, wherein a narrow wall at least partially surrounds the transparent portion and projects from a surface of the panel-form member.

15. A mobile telephone according to claim 14, wherein the wall projects from the surface of the panel-form member that faces the cavity when the panel-form member is in the first position, and supports the resilient member.

16. A mobile telephone according to claim 1, wherein the panel-form member is a resonant member, and the transducer causes the panel-form member to resonate to act as an acoustic radiator.

17. A mobile telephone according to claim 1, comprising a screen mounted in the body, the panel-form member comprising a transparent portion whereby the screen is visible with the panel-form member in the first position.

18. A mobile telephone according to claim 17, wherein the transducer is mounted at a marginal position on the panel-form member and is spaced away from the transparent portion so as not to obscure a user's view of the screen.

19. A mobile telephone according to claim 18, wherein a narrow wall at least partially surrounds the transparent portion and projects from a surface of the panel-form member.

20. A mobile telephone according to claim 19, wherein the wall projects from the surface of the panel-form member that faces the cavity when the panel-form member is in the first position, and supports the resilient member.

21. A mobile telephone according to claim 17 or claim 18, wherein the panel-form member is a resonant member, and the transducer causes the panel-form member to resonate to act as an acoustic radiator.

22. A mobile telephone according to claim 21, wherein the panel-form member and the transducer also act together as a microphone.

23. A mobile telephone comprising a body and a bending wave loudspeaker pivotally mounted to the body which comprises a resonant panel-form member capable of supporting bending waves and a transducer mounted to the panel-form member to excite bending wave vibration in the panel-form member to cause the panel-form member to resonate to produce an acoustic output, wherein the body defines an open-faced cavity and the panel-form member is hinged at its edge to the body and is movable between a first position in which the panel-form member covers the open face of the cavity to enclose a volume of air in the cavity, and a second position in which the panel-form member is spaced away from the cavity, the cavity being configured to define rear boundary conditions of the loudspeaker that ensure the loudspeaker has a desired bandwidth when operating with the panel-form member in the first position.

24. A mobile telephone according to claim 23, comprising a screen mounted in the body and visible through the open face of the cavity, the panel-form member comprising a transparent portion whereby the screen is visible through the transparent portion with the panel-form member in the first position.

25. A mobile telephone according to claim 24, wherein the transducer is mounted at a marginal position on the panel-form member and is spaced away from the transparent portion so as not to obscure a user's view of the screen.

26. A mobile telephone according to claim 25, wherein a narrow wall at least partially surrounds the transparent portion and projects from the surface of the panel-form member that faces the cavity when the panel-form member is in the first position.

27. A mobile telephone according to claim 26, wherein the cavity is sealed by a resilient member disposed between the panel-form member and the body when the panel-form member is in the first position.

28. A mobile telephone according to claim 27, wherein the wall supports the resilient member.

29. A mobile telephone according to claim 23, wherein the panel-form member and the transducer also act together as a microphone.
